(19) United States
(12) Patent Application Publication
(10) Pub. No.: US 2023/0294138 A1
(43) Pub. Date: Sep. 21, 2023

(54) CLEANING DEVICE AND METHOD FOR CLEANING ARTICLES TO BE CLEANED

(71) Applicant: MEIKO Maschinenbau GmbH and Co. KG, Offenburg (DE)

(72) Inventors: Bruno Gaus, Offenburg (DE); Marc Scherer, Hofstetten (DE)

(73) Assignee: MEIKO Maschinenbau GmbH and Co. KG, Offenburg (DE)

(21) Appl. No.: 18/041,378

(22) PCT Filed: Aug. 12, 2021
(86) PCT No.: PCT/EP2021/072462

§ 371 Date: Feb. 10, 2023

(30) Foreign Application Priority Data
Aug. 13, 2020 (DE) 102020210272.4

(51) Int. Cl. B08B 1/00; B08B 3/02

(52) U.S. Cl. CPC B08B 1/006; B08B 3/02

(57) ABSTRACT

Proposed is a cleaning device (110) for cleaning articles (112) to be cleaned, a cleaning basket (114) for use in a cleaning device (110), a method for cleaning articles (112) to be cleaned and a use of a cleaning device (110). The cleaning device (110) comprises at least one cleaning chamber (116) for stationarily receiving at least one cleaning basket (114) with the articles (112) to be cleaned contained therein. Furthermore, the cleaning device (110) comprises at least one application device (118) for applying at least one cleaning fluid (120) to the articles (112) to be cleaned. The cleaning device (110) also comprises a plurality of movable cleaning elements (154), wherein: the movable cleaning elements (154) are arranged to move relative to the cleaning basket (114); the movable cleaning elements (154) are configured to remain in the cleaning chamber (116) while the cleaning fluid (120) is being applied to the articles (112) to be cleaned; the movable cleaning elements (154) are configured to be set in motion by the cleaning fluid (120); and the movable cleaning elements (154) are configured to exercise a mechanical cleaning effect on the articles (112) to be cleaned while the cleaning fluid (120) is being applied to the articles (112) to be cleaned.

### TECHNICAL FIELD

The invention relates to a cleaning device and to a method for cleaning articles for cleaning. The invention furthermore relates to the use of the proposed cleaning device to clean personal protective equipment. The cleaning device and the method may be used for example in particular in the field of cleaning of personal protective equipment and in particular breathing protection masks and/or breathing apparatus. The invention may however in principle also be used in other fields, for example in the field of dishwasher technology, in particular in the field of industrial dishwasher technology. In particular, the invention may be used in industrial kitchens in which heavily soiled articles for cleaning, for example containers or large cooking vessels, must be cleaned. Other fields of use are however also conceivable in principle.

### TECHNICAL BACKGROUND

The prior art has disclosed a large number of cleaning devices, also referred to as cleaning appliances, which can clean and/or disinfect articles for cleaning. By way of example, reference may be made to cleaning devices that are described for example in DE 10 2004 056 052 A1 or in DE 10 2007 025 263 A1.

Without limiting further possible refinements, the invention will be described below with reference to articles for cleaning that comprise items of personal protective equipment. As articles for cleaning, use could however alternatively or additionally also be made, for example, of articles that serve for the presentation, preparation or storage of meals, or other types of articles for cleaning.

Personal protective equipment is used for example by emergency services personnel, military personnel or law enforcement personnel. Important elements of personal protective equipment generally include breathing apparatuses and the constituent parts thereof, such as breathing protection masks and/or breathing regulators. Numerous breathing apparatuses for different purposes are known from the prior art. For example, emergency services personnel such as fire service personnel use breathing protection masks with filters for removing harmful constituents from the aspirated respiratory air. In many cases, as an alternative or in addition to a filter, a so-called breathing regulator is used, by means of which the user can be ventilated with a respiratory gas, for example compressed air. Breathing regulators, commonly also referred to as respiratory regulators, generally enable a user to breathe from a compressed-gas bottle or some other compressed-gas connection, and to thereby remain for example underwater or in some other non-respirable or poisonous atmosphere. For this purpose, the compressed gas, for example compressed air, from the compressed-gas connection is adapted by the breathing regulator to a pressure prevailing in a working environment of the user.

Breathing apparatuses or elements thereof must generally be cleaned, sanitized, dried, inspected, and optionally refurbished and packaged, after every use. The cleaning operation is intended to remove all contaminants for example resulting from use or storage, such that the breathing apparatuses can be made available in macroscopically clean and hygienically sound form, for example for the next steps of a treatment process. The same requirements generally also apply to other elements of breathing apparatuses, such as attachment and accessory parts of breathing masks, for example carrying racks, compressed-gas bottles, filters or breathing regulators. Since breathing apparatuses or the elements thereof are generally safety-relevant devices, numerous requirements must be adhered to when cleaning these devices. Aside from adequate cleaning and sanitization, it is for example necessary in many cases to ensure that accessory parts remain assigned to the respective breathing masks for technical reasons. Furthermore, it is generally a requirement that gas-conducting regions of particular elements of breathing apparatuses, for example gas-conducting regions of breathing regulators, do not come into contact with cleaning fluid, for example do not come into contact with water and/or cleaning solution.

In many cases, breathing apparatuses such as breathing masks and their accessories are either cleaned by hand or are washed in modified laundry washing machines with the aid of protective bags and/or with the aid of adapters. For example, EP 0 935 687 B1 has generally disclosed a washing machine that has a suds container with a drum. A shell of the drum has a domed structure directed toward the drum interior, with perforations being arranged on edge contours of the dome that are directed toward the drum interior, at the corner points of said edge contours. Particularly gentle cleaning of articles of equipment for emergency services personnel is possible in principle with such washing machines.

EP 1 088 928 A1 has disclosed a holding system for breathing protection masks in a laundry treatment machine. The holding system has a carrying bracket which is arranged in a drum of the laundry treatment machine so as to co-rotate and to which the breathing protection masks can be connected.

DE 200 03 743 U1 and DE 298 22 172 U1 have each disclosed devices for treating protective garments. Here, use is made of clothes hangers that comprise flexible air outlet nozzles. The clothes hangers are each fastened to a swivel device. Cleaning of breathing apparatuses is generally not possible, or is possible only with difficulty, using the devices presented.

DE 10 2005 033 618 B3 has disclosed a device for cleaning breathing protection masks. The device comprises a closable housing and at least one receptacle, arranged in a carrier, for at least one breathing protection mask. Also provided are a nozzle arrangement and a brush arrangement, with the breathing protection masks being brushed as a result of a movement of the breathing protection masks. Individual assignment and cleaning of accessory parts of masks is however not possible using the device disclosed. Furthermore, it is not possible for gas-conducting elements, for example breathing regulators, to be cleaned using the device disclosed. DE 200 03 744 U1 has also disclosed a device for cleaning, disinfecting and drying breathing protection masks, which device has a carrying rack with an associated nozzle system and individual treatment locations. This device, too, is in principle not suitable for cleaning gas-conducting elements and accessory parts.

DE 10 2007 009 936 A1 has disclosed a cleaning device for compressed-air breathing apparatuses. Said cleaning device has a receiving space delimited by a protective frame, and rotating nozzle carriers. The nozzle carriers are in this case situated outside the protective frame. A disadvantage of the device presented is however that cleaning liquid can enter gas-conducting regions.

By contrast, sensitive elements of breathing apparatuses, such as breathing regulators, are generally cleaned manually. Manual cleaning may optionally be assisted by placing such elements into ultrasound cleaning appliances. DE 10 2007 012 768 B4 has disclosed a method and a device for cleaning breathing regulators. Here, the articles for cleaning are mounted on holders of a rotating element and are immersed multiple times in a liquid bath with cleaning liquid, disinfection liquid and rinsing liquid. Here, breathing regulators are firstly charged with compressed air in order to establish a seal between valve and hose connector, and are subsequently immersed in the liquid bath. A disadvantage of such immersion methods is however that complex holders with corresponding actuators are necessary in order to ensure, by way of corresponding movements, that cleaning fluid is removed from the various cavities after the cleaning operation.

DE 100 20 835 A1 describes a device for treating breathing protection masks. A receptacle for the placement of breathing protection masks is provided, in the case of which the breathing protection masks are coupled to the receptacle by way of the breathing apparatus connection. It is also described that a collecting means for collecting treatment media, and a pump for the feed of the treatment media, are provided in a cabin of the device.

U.S. Pat. No. 3,881,503 A discloses a device for washing and decontaminating articles of anesthetic equipment. A nozzle system is provided that can be used to spray highly pressurized water jets onto the articles for cleaning.

DE 11 74 169 B describes a device for cleaning breathing protection masks. Here, a rotatably supported tubular rack is provided in a housing, in which tubular rack the masks for cleaning are mounted onto holders. Using the rotary rack, the breathing protection masks are moved in a rotational motion through a bath of a cleaning liquid in a tub.

WO 2011/144518 A2 describes a cleaning device for cleaning breathing apparatuses. The cleaning device comprises at least one cleaning chamber for receiving at least one breathing apparatus, and at least one fluid device for applying at least one cleaning fluid to the breathing apparatus. The cleaning device furthermore has at least one pressurizing device with at least one pressure connector. The pressure connector is connectable to at least one gas-conducting element of the breathing apparatus. The pressurizing device is configured to charge the gas-conducting element with compressed gas.

US 2012/0284938 A1 describes a dishwasher that uses the abrasive forces of brushes to clean dishware. The dishware is held from above by a rack composed of parallel rods, such that the upper oscillating brush can extend through the rack and clean the outside of the dishware. The dishware is held from below by the axle of the lower rotating brush, such that the brush rotates in order to clean the inside of the dishware. The dishwasher is furthermore composed of a rotating rack that holds the dishware at the beginning of and during the rinsing cycle. The rotating rack is composed of rods that support the dishware, a water slot for conducting rinsing water into the rinsing chamber, and a movable cover that regulates the flow of the washing fluid into corresponding chambers.

DE 10 2017 202 055 A1 describes a cleaning device for cleaning articles for cleaning, which cleaning device comprises at least one cleaning chamber and at least one application device for applying at least one cleaning fluid to the articles for cleaning in the cleaning chamber. The cleaning device furthermore comprises at least one controller that is configured to control the cleaning device so as to implement at least two operating modes. The controller is furthermore configured to detect at least one utilization variable. The utilization variable characterizes a present utilization of the cleaning device. The controller is furthermore configured to assign at least one weighting to the at least one utilization variable. The controller furthermore has at least one counter device that is configured to cumulate the utilization times, weighted with the weighting, of the cleaning device and to generate therefrom at least one item of usage information relating to usage of the cleaning device.

Despite the advantages that have been and will be achieved with the above-described devices and methods, numerous technical challenges remain. In particular, one challenge consists in that, in many cases, combustion residues, specifically soot, adhere to the outer surfaces of personal protective equipment. This adherent matter can in many cases be removed from the surfaces using the known methods only with difficulty, in particular because many articles of personal protective equipment, such as compressed-air breathing apparatuses, can only be cleaned at relatively low temperatures. A particular role is played here by surface effects, which have the effect, for example, that soot adheres particularly strongly to various synthetic surfaces owing to electrostatic charge. It is accordingly scarcely possible in practice for the combustion residues to be completely rinsed off, in particular at low temperatures.

### OBJECT OF THE INVENTION

It would therefore be desirable to provide a cleaning device and a method for cleaning articles for cleaning, which at least substantially avoid the disadvantages of known devices and methods of the prior art. In particular, the cleaning device and the method should be usable for cleaning articles for cleaning with combustion residues, such as personal protective equipment or cooking vessels.

### GENERAL DESCRIPTION OF THE INVENTION

This object is addressed by a cleaning device and a method for cleaning articles for cleaning, and by the proposed use of the cleaning device for cleaning personal protective equipment, having the features of the independent patent claims. Advantageous refinements that can be implemented individually or in any desired combination are presented in the dependent claims, as will be apparent to a person skilled in the art.

Below, the expressions “have”, “feature”, “comprise” or “include”, or any grammatical deviations therefrom, are used non-exclusively. Accordingly, these expressions may relate both to situations in which no further features other than those introduced by these expressions are present, or to situations in which one or more further features are present. For example, the phrase “A has B”, “A features B”, “A comprises B” or “A includes B” may relate both to the situation in which no further element other than B is present in A (that is to say to a situation in which A consists exclusively of B), and to the situation in which one or more further elements in addition to B, for example element C, elements C and D, or even further elements, are present in A.

It is also pointed out that the expressions “at least one” and “one or more”, and grammatical modifications of these expressions, where they used in conjunction with one or more elements or features and are intended to express that the element or feature may be provided in singular or multiple form, are generally used only once, for example when the feature or element is first introduced. When the feature or element is subsequently mentioned again, the corresponding expression “at least one” or “one or more” will generally not be used again, without limiting the possibility that the feature or element may be provided in singular or multiple form.

Furthermore, the expressions “preferably”, “in particular”, “for example” or similar expressions will be used in conjunction with optional features, without this limiting alternative embodiments. Accordingly, features introduced using these expressions are optional features, and these features are not intended to limit the scope of protection of the claims and in particular of the independent claims. Accordingly, the invention may also be implemented using other refinements, as will be apparent to a person skilled in the art. Similarly, features introduced by “in one embodiment of the invention” or by “in one exemplary embodiment of the invention” are to be understood as optional features, without this being intended to limit alternative refinements or the scope of protection of the independent claims. Furthermore, these introductory phrases are not intended to affect any possibilities of combining the features thereby introduced with other features, be they optional or non-optional features.

In a first aspect, a cleaning device for cleaning articles for cleaning is proposed. As stated above, the articles for cleaning may in particular involve at least one article of personal protective equipment, in particular at least one article that comprises at least one breathing apparatus. As stated above, however, other types of articles for cleaning are alternatively or additionally also conceivable, for example one or more articles that are used for the presentation, preparation or storage of meals. The articles for cleaning may generally be articles with combustion residues, in particular soot, adhered thereto.

The expression “cleaning device” as used here is a broad expression that should be attributed its normal and conventional meaning as it is understood by a person skilled in the art. The expression is not limited to a special or amended meaning. In particular, the expression may, without limitation, relate to a device that is configured to remove adherent macroscopic or even microscopic contaminants from articles for cleaning, or to at least partially eliminate such contaminants. Furthermore, a disinfecting action may optionally be imparted. As stated in more detail further below, the cleaning device may be designed in particular as a washer, for example as a washer for personal protective equipment and/or as a dishwasher, for example as a container washer. Here, the washer may be designed in particular as a single-chamber washer, in particular as an industrial single-chamber washer with a multi-circuit wash system, as a front-door washer, or as a hood-type washer, in particular as a pass-through washer. Dishwashers with a water change facility, in particular so-called single-circuit systems, may also be used. Alternatively or in addition to dishwashers, other types of cleaning devices may also be used.

The cleaning device comprises at least one cleaning chamber for receiving at least one cleaning basket, with the articles for cleaning received therein, in a static manner. The expression “cleaning chamber” as used here is a broad expression that should be attributed its normal and conventional meaning as it is understood by a person skilled in the art. The expression is not limited to a special or amended meaning. The expression may, without limitation, relate in particular to a completely or partially closed chamber, within which the cleaning operation can be entirely or partially performed. In particular, the cleaning chamber may have at least one housing that entirely or partially encloses the cleaning chamber. Here, a single cleaning chamber may be provided, or it is also possible in principle for multiple cleaning chambers to be provided, for example in a sequential configuration. The cleaning chamber may for example have at least one opening for the loading of the articles for cleaning into the cleaning chamber. For example, this may be an opening with a flap arranged at a front side of the cleaning chamber and/or a top side of the cleaning chamber. Hoods for closing the cleaning chamber are alternatively also possible, for example in the context of so-called hood-type dishwashers or pass-through washers. Other refinements are also possible in principle.

The cleaning chamber is configured to receive the at least one cleaning basket. For this purpose, the cleaning chamber may for example have at least one basket receptacle, for example at least one rail, into which the cleaning basket can be pushed, and/or at least one holding device or transport device, by means of which the basket can be transported into the cleaning chamber, out of the cleaning chamber or through the cleaning chamber.

Here, as stated above, the cleaning device is designed such that the cleaning basket is held in a static manner during the cleaning operation, in particular when at least one cleaning fluid is applied in a manner that will be described in more detail below. This may mean in particular that the cleaning basket is held on or in at least one basket receptacle during the cleaning operation, and is for example not swiveled, rotated, raised, immersed or similarly moved during the cleaning operation. For example, the cleaning basket may remain static when the at least one cleaning fluid is applied. For example, the cleaning chamber may be designed as a single chamber in which the at least one cleaning basket can be received, for example in a basket receptacle, wherein the cleaning basket is received in such a way, in particular by way of a corresponding design of the basket receptacle, that the cleaning basket is at rest and remains static, that is to say for example is not moved in translation and/or rotation, during the cleaning operation, in particular when the cleaning fluid is applied. In particular, a basket base of the cleaning basket may for example remain in a horizontal situation during the cleaning operation. It however remains possible for the cleaning basket to be manually or automatically removed from the cleaning chamber or the corresponding cleaning zone after the cleaning fluid has been applied, wherein a further cleaning operation and/or a different type of treatment, for example, may subsequently be performed.

The cleaning device furthermore comprises at least one application device for applying at least one cleaning fluid to the articles for cleaning. The expression “application device” as used here is a broad expression that should be attributed its normal and conventional meaning as it is understood by a person skilled in the art. The expression is not limited to a special or amended meaning. In particular, the expression may, without limitation, relate in principle to any device that can be used to apply the cleaning fluid, in particular at least one cleaning liquid, to the articles for cleaning within the cleaning chamber.

Here, an “application” may be understood generally to mean any establishment of contact between the cleaning fluid and the articles for cleaning. This may take place in particular in the form of a direct application, for example by spraying, sprinkling, jetting or a combination of the abovementioned and/or other direct forms of application, in the case of which the pre-cleaning fluid impinges directly on the articles for cleaning, for example the breathing apparatus and/or the breathing mask, preferably with an impulse greater than zero. The application may take place in a single operation, by virtue of the cleaning fluid being applied only once to the articles for cleaning. Cleaning may however alternatively or additionally also be performed by circulation operation, by virtue of cleaning fluid being applied multiple times to the articles for cleaning. Such circulation operation and circulation circuits are for example known from conventional dishwashers or washing machines. Circulation operation may be implemented for example using at least one circulation pump, by means of which cleaning fluid that has already been applied to the articles for cleaning is collected and applied again. A combination of a single operation and circulation operation is also possible, for example by virtue of at least one washing fluid being applied in circulation operation in at least one washing step, which is followed by at least one rinsing step, also referred to as clear rinsing step, in which at least one rinsing fluid is applied in a single operation.

The application device may in particular comprise at least one nozzle system, for example at least one nozzle arm, for example at least one rotatably mounted nozzle arm. For example, in the cleaning chamber, at least one nozzle arm, for example a rotatably mounted nozzle arm, may be arranged below the articles for cleaning, and at least one nozzle arm, for example a rotatably mounted nozzle arm, may be arranged above the articles for cleaning. Here, separate nozzle arms for washing fluid and rinsing fluid may for example be provided in each case above and below the articles for cleaning. Furthermore, the application device may comprise at least one pump, and at least one line system, for providing cleaning fluid to the nozzle system. For example, a nozzle system and a line system for applying cleaning fluid from at least one tank, for example at least one washing tank, may be provided, along with at least one pump, for example at least one washing pump. Furthermore, at least one nozzle system and at least one line system for applying cleaning fluid from at least one optional rinsing tank, which is preferably separate from the washing tank and in which rinsing liquid can be treated separately from the washing tank, may be provided, along with at least one rinsing pump. Through the provision of at least one rinsing tank which is separate from the washing tank, the cleaning device can be directed to industrial applications, since the fact that the rinsing fluid is treated separately already during a washing step means that heating time can be saved. For example, the rinsing tank may be designed as a boiler and/or may have a continuous-flow heater.

The expression “cleaning fluid” as used here is a broad expression that should be attributed its normal and conventional meaning as it is understood by a person skilled in the art. The expression is not limited to a special or amended meaning. In particular, the expression may, without limitation, relate to a fluid and in particular a liquid that can impart a cleaning action when it impinges on the articles for cleaning. In particular, the cleaning liquid may comprise an aqueous liquid, for example water and/or water with one or more additives, for example with one or more cleaner concentrates and/or rinse aids and/or disinfectants. The cleaning device may be configured to use a single cleaning liquid or to use a combination of several cleaning liquids. If multiple cleaning liquids are provided, the different cleaning liquids may be applied simultaneously or sequentially to the articles for cleaning. For example, as stated above, the articles for cleaning may remain static within the cleaning chamber, and the different cleaning fluids may be applied to said articles for cleaning in succession. It is alternatively also possible for different types of cleaning fluids to be applied to the articles for cleaning in succession at different locations, for example in different chambers, for example by virtue of the articles for cleaning initially remaining stationary in a first cleaning chamber, a first cleaning fluid being applied to said articles for cleaning therein, and the articles for cleaning thereupon being moved into at least one second cleaning chamber and remaining stationary there, and at least one second cleaning fluid being applied to said articles for cleaning. Without limiting further possible refinements, reference will be made below to batch washers, in which the articles for cleaning remain static in a single cleaning chamber during the cleaning process.

The cleaning device may for example be configured to use the application device to carry out at least one cleaning program, for example in a manner controlled by at least one controller of the cleaning device, in which at least one cleaning program the articles for cleaning, for example the at least one cleaning basket with the articles for cleaning, are received in the cleaning chamber in a static manner and have cleaning fluid applied thereto successively in different ways in one or more cleaning steps of the cleaning program, for example firstly the at least one washing fluid in at least one washing step and the at least one rinsing fluid in at least one rinsing step. Furthermore, at least one drying step may be provided, which may for example follow the application of the cleaning fluid in the single cleaning chamber while the articles for cleaning are held in a static manner. Accordingly, the cleaning device may be designed in particular as a batch washer.

The expression “tank” as used here is a broad expression that should be attributed its normal and conventional meaning as it is understood by a person skilled in the art. The expression is not limited to a special or amended meaning. In particular, the expression may, without limitation, relate to a completely or partially closed vessel that is configured to receive at least one cleaning fluid, in particular at least one liquid. As stated above, the at least one tank may for example have at least one washing tank. Said at least one washing tank may for example be arranged in a base of the cleaning chamber, or else may be fluidically connected to a base of the cleaning chamber, such that cleaning fluid can flow from the cleaning chamber into the washing tank. For example, the washing tank may be separated from the cleaning chamber by at least one screen. In addition to the at least one washing tank, the at least one tank may furthermore also comprise one or more further tanks. Accordingly, the at least one tank may for example have at least one rinsing tank, which may for example be separate from the washing tank. For example, at least one rinsing fluid, also referred to as clear rinsing fluid, may be treated, for example temperature-controlled, in the at least one rinsing tank while a washing step is still taking place in the cleaning chamber. The rinsing tank may for example comprise at least one boiler.

The cleaning device furthermore comprises a multiplicity of movable cleaning elements. The movable cleaning elements are arranged so as to be movable relative to the cleaning basket and are configured to remain in the cleaning chamber as the cleaning fluid is applied to the articles for cleaning. Furthermore, the movable cleaning elements are configured to be set in motion by the cleaning fluid, in particular a flow of the cleaning fluid, the movable cleaning elements being configured to exert a mechanical cleaning action on the articles for cleaning as the cleaning fluid is applied to the articles for cleaning.

The expression “cleaning element” as used here is a broad expression that should be attributed its normal and conventional meaning as it is understood by a person skilled in the art. The expression is not limited to a special or amended meaning. In particular, the expression may, without limitation, relate in principle to any form of device that is configured to mechanically act on articles for cleaning in order to achieve a mechanical cleaning action. In particular, the device may be produced entirely or partially from one or more solid materials, that is to say one or more materials of solid phase, which may preferably be flexible or deformable. The expression “cleaning element” as used herein is to be understood accordingly. This, too, should be attributed its normal and conventional meaning as it is understood by a person skilled in the art. The expression is not limited to a special or amended meaning. In particular, the expression may, without limitation, relate to a cleaning element within the above definition, which is designed to be at least partially movable. Here, the mobility may be such that the cleaning element can move freely in the cleaning chamber. This may be the case for example if the movable cleaning elements or at least a part of the movable cleaning elements comprise multiple solid bodies, for example balls or other three-dimensional bodies, which are freely movable in the cleaning chamber but which cannot leave the cleaning chamber. The movable cleaning elements may however alternatively or additionally also, at least in part, be designed to be only partially movable. This partial mobility may arise for example from the fact that the movable cleaning elements are fastened by way of at least one part, for example to at least one wall of the cleaning chamber and/or to the cleaning basket, and are designed such that at least one other part thereof is movable, such that at least the movable part can mechanically act on the articles for cleaning in the cleaning basket. This may be achieved for example by virtue of the cleaning elements being designed as ribbons, loops or strands, which are fastened for example at one end or by way of one part, for example to at least one wall of the cleaning chamber, in particular in the region of a ceiling of the cleaning chamber, and/or to the cleaning basket, and which have at least one freely movable part or one freely movable portion, for example a freely movable end, which can mechanically act on the articles for cleaning. For example, the movable cleaning elements may be dimensioned in terms of their length so as to extend from the fastened part at least to the cleaning basket, in particular to a base of the cleaning basket or to just above same, such that said movable cleaning elements can mechanically act, by way of the movable part, on the articles for cleaning. The mobility may thus relate in particular to the mobility of at least one free part of the cleaning elements, for example to at least one free end, which may be freely movable relative to the cleaning basket.

As stated above, the movable cleaning elements are configured to remain in the cleaning chamber as the cleaning fluid is applied to the articles for cleaning. This may be achieved in particular by virtue of the movable cleaning elements being fastened by way of at least one part to the cleaning chamber and/or to the cleaning basket. It is however alternatively also possible for the movable cleaning elements to move freely in the cleaning chamber, as stated above. In this case, it can be ensured for example by means of at least one screen and/or at least one grille that said cleaning elements do not leave the cleaning chamber. Alternatively, the cleaning elements may also be dimensioned in terms of their size such that they cannot leave the cleaning chamber, for example by being designed to be larger than a drain cross section. Further alternatively or in addition, the cleaning elements may be received in at least one retaining element within the cleaning chamber, for example at least one basket, such that, for example, the cleaning basket itself may also be designed as a closed basket with the cleaning elements received and freely movable therein.

As stated above, the movable cleaning elements are configured to be set in motion by the cleaning fluid, in particular a flow of the cleaning fluid. Accordingly, the movable cleaning elements may be arranged in particular in the region of droplets or jets of the cleaning fluid emerging from the application device, in particular from one or more nozzles of the application device, and may be designed in terms of their mass and/or density and/or their mobility such that said droplets or jets from the application device set the movable cleaning elements entirely or partially in motion. For example, the application device may be configured in this way such that, for example, a pump power and/or an orientation of the nozzle elements of the application device are configured for correspondingly applying an impulse to the movable cleaning elements by way of droplets and/or jets of the cleaning fluid. If, for example, the movable cleaning elements are designed entirely or partially as ribbons or strands, which for example extend vertically in a rest state owing to the gravitational force acting thereon, the application device may for example be configured such that the droplets and/or jets of the cleaning fluid impinge on the movable cleaning elements with a direction of movement transverse with respect to the vertical, with said movable cleaning elements being subjected to an impulse with at least one impulse component in a horizontal direction and thus being set in motion.

As stated above, the movable cleaning elements are configured to exert a mechanical cleaning action on the articles for cleaning as the cleaning fluid is applied to the articles for cleaning. This is possible in particular by virtue of the fact that at least a part of the movable cleaning elements, which part is subjected to an impulse by the cleaning fluid when the latter is applied, can act on the articles for cleaning in the cleaning basket. As stated above, said movable part may in particular be a movable end of the movable cleaning elements, for example a free end. As stated above, however, the movable cleaning elements may alternatively or additionally also be movable as a whole, and act as a whole on the articles for cleaning. In general, the mechanical action can for example result in rubbing, in particular rubbing of combustion residues such as soot, from at least one surface of the articles for cleaning. Other forms of contaminants, such as greases and/or adherent starches, can also be removed from the at least one surface by the mechanical action.

The movable cleaning elements may in particular, as stated above, be produced at least partially from at least one flexible material. Here, a flexible material may be understood in particular to mean a deformable material, in particular a material that can reversibly deform under the action of its own weight. Said flexible material may in this case have elastic or plastic characteristics. Combinations of several materials are also possible.

In particular, the movable cleaning elements may be produced at least partially from at least one textile material. Textile materials may in particular comprise at least one material selected from the group comprising: a woven fabric, a warp-knitted fabric, a weft-knitted fabric, a braided fabric; a stitch-bonded fabric; a nonwoven fabric; a felt. Natural materials or synthetics may be used here. In particular, the textile material may have at least one material selected from the group comprising: a natural fiber; cotton; a textile synthetic material, in particular a textile synthetic material selected from the group comprising: polyester; polyamide, in particular Nylon®. Other materials that can be processed to form textiles may however also be used in principle.

Alternatively or in addition to the use of at least one textile material, the movable cleaning elements may be produced at least partially from at least one synthetic material. Said textile synthetic material may in particular be at least one elastomer material. Alternatively or in addition, use may however also be made of other synthetic materials, in particular thermoplastic synthetic materials. For example, the at least one synthetic material may be used in the form of material strips. The at least one synthetic material may however alternatively or additionally also be used for example in the form of strands, which may then for example also be processed form a textile synthetic material, which in turn may for example be used in the form of ribbons. Alternatively or in addition, the at least one synthetic material may for example also comprise at least one foam material, for example a foam material in the form of ribbons. In particular, the at least one synthetic material may be selected from the group comprising: ethylene propylene diene monomer; polyurethane.

As stated above, the movable cleaning elements or at least a part of the movable cleaning elements may in particular at least partially have an elongate flexible form. In particular, said form may be that of ribbons and/or strands. Other elongate forms are also conceivable.

The movable cleaning elements or at least a part of the movable cleaning elements may in particular have at least one shape selected from the group comprising: a ball shape; a strand shape; a ribbon shape. The ball shape may for example be selected in the case of cleaning elements that are movable freely within the cleaning chamber. For example, use may be made of balls composed of a textile material and/or balls composed of a lightweight material such as a lightweight synthetic material, or hollow balls lined with a textile surface. In general, the movable cleaning elements may have at least one textile surface that can exert a rubbing action on the contaminated surface.

As has furthermore been stated above, as an alternative or in addition to cleaning elements that are movable entirely freely within the cleaning chamber or within a part of the cleaning chamber, movable cleaning elements may be provided which are fastened within the cleaning chamber and/or to the cleaning basket. In particular, the movable cleaning elements may be fastened at least partially in the cleaning chamber. For example, the movable cleaning elements may be attached directly or indirectly by way of at least one part to a ceiling of the cleaning chamber and/or to another part of a wall of the cleaning chamber and/or to a part that is connected to a wall of the cleaning chamber, for example a ceiling of the cleaning chamber. For example, ribbons and/or strands may hang directly from a ceiling of the cleaning chamber or from a part, for example a plate, that is connected to the ceiling or to some other part of the cleaning chamber. In this case, the ribbons and/or strands may for example extend vertically through the cleaning chamber.

As stated above, the movable cleaning elements may each have at least one freely movable part, in particular a free end, which is configured to mechanically act on the articles for cleaning. In particular, the freely movable part may lie on the articles for cleaning owing to the gravitational force acting on said freely movable part.

The cleaning device may furthermore have at least one freeing device that is configured to mechanically separate the freely movable parts of the movable cleaning elements from the articles for cleaning. The expression “freeing device” as used here is a broad expression that should be attributed its normal and conventional meaning as it is understood by a person skilled in the art. The expression is not limited to a special or amended meaning. In particular, the expression may, without limitation, relate to any device, in particular a mechanical device, which is configured to mechanically act on the movable cleaning elements or at least a part thereof so as to separate same from the articles for cleaning. This may be advantageous in particular during loading or unloading of the cleaning device, for example in order to prevent the movable cleaning elements from obstructing an introduction of the cleaning basket into the cleaning chamber and/or a removal of the cleaning basket from the cleaning chamber. However, the freeing device may alternatively or additionally also bring about the separation during one or more program steps of a cleaning program, for example during a rinsing step and/or during a drying step. Cleaning fluid from a preceding program step that is adhering to the movable cleaning elements can thus be prevented, for example, from disrupting the program step that is presently taking place, for example the drying step.

In particular, the freeing device may have at least one pusher. Said pusher may in particular be configured to push the freely movable parts of the movable cleaning elements away from the articles for cleaning. Alternatively or in addition to at least one pusher, however, other freeing devices may also be used, for example at least one swivel arm or similar mechanical devices.

As stated above, a single freeing device may be provided. Multiple freeing devices, or multiple parts of the freeing device, are however also possible. Accordingly, the freeing device may in particular have at least two sub-devices, the sub-devices being configured to move the freely movable parts of the movable cleaning elements away from the articles for cleaning in at least two different directions. For example, the at least two parts may comprise two or more pushers that can move in different directions. For example, a bundle of the movable cleaning elements, for example a bundle of ribbons or strands, may be pushed in a single direction by the freeing device, or else may be divided into partial bundles that can be pushed in different directions. The latter may for example take place analogously to the opening of a curtain composed of multiple parts, wherein the curtain may in this case be composed for example of ribbons and/or strands.

The freeing device may in particular be configured to automatically mechanically separate the freely movable parts of the movable cleaning elements from the articles for cleaning when the cleaning chamber is opened. When the cleaning chamber is closed, the freeing device may be configured to eliminate the separation, and in particular allow contact again between the freely movable parts of the movable cleaning elements and the articles for cleaning.

As stated above, the movable cleaning elements may in particular be fastened directly or indirectly at at least one part to the cleaning device, in particular to at least one part of the cleaning chamber. In particular, the movable cleaning elements may be fastened at least partially to at least one movable element of the cleaning device. The cleaning device may be configured to set the movable cleaning elements in motion by means of the movable element in addition to the movement caused by the cleaning fluid. For example, the movable element may have at least one oscillating plate on a ceiling of the cleaning chamber, for example a vibrating plate or a plate that is moved by at least one eccentric or some other oscillating actuator. In this way, it is for example possible for the freely movable parts, in particular the free ends, of the movable cleaning elements to be moved back and forth on the articles for cleaning in order to generate an additional rubbing action.

Furthermore, in the cleaning device according to the present invention, which may be configured specifically for personal protective equipment, the above-described protection of gas-conducting elements during the application of cleaning fluid may be implemented in order to ensure that cleaning fluid cannot enter the interior of the gas-conducting elements. Accordingly, the cleaning device may in particular have at least one pressurizing device with at least one pressure connector, the pressure connector being connectable to at least one gas-conducting element of the articles for cleaning, in particular of the breathing apparatus. The pressurizing device may be configured to charge the gas-conducting element with pressurized gas as the at least one cleaning fluid is applied to the articles for cleaning.

The expression “pressurizing device” as used here is a broad expression that should be attributed its normal and conventional meaning as it is understood by a person skilled in the art. The expression is not limited to a special or amended meaning. In particular, the expression may, without limitation, relate to a device that is configured to be able to provide a fluid, in particular a gas, at a pressure above the normal pressure, for example a pressure of at least 1.5 bar, preferably a pressure of at least 2 bar. The expression “pressure connector” as used here is a broad expression that should be attributed its normal and conventional meaning as it is understood by a person skilled in the art. The expression is not limited to a special or amended meaning. In particular, the expression may, without limitation, relate in principle to any connection of the pressurizing device via which the fluid, in particular the gas, can be provided to the pressurizing device. In particular, said pressure connector may be arranged in the interior of the cleaning chamber and/or may be accessible from the interior of the cleaning chamber. It is also conceivable for multiple pressure connectors to be provided.

The pressure connector may be connectable to at least one gas-conducting element of the articles for cleaning, in particular of the personal protective equipment and in particular of the breathing apparatus, in the cleaning chamber, preferably to multiple gas-conducting elements of several of the articles for cleaning. The expression “gas-conducting element” as used here is a broad expression that should be attributed its normal and conventional meaning as it is understood by a person skilled in the art. The expression is not limited to a special or amended meaning. In particular, the expression may, without limitation, relate to an element which is charged with at least one gas during use of the articles for cleaning, and which in particular is charged with a respiratory gas by a human or animal user during use of the personal protective equipment, for example of the breathing apparatus, or which can come into contact with the respiratory gas in some other way. In particular, said gas-conducting element may be a breathing regulator and/or a breathing hose with at least one valve. In particular, the gas-conducting element may be an element which has at least one hose and/or at least one other form of gas-conducting device with an interior space and/or at least one valve, to which cleaning fluid generally must not be applied. For example, the gas-conducting element may be a region of the breathing apparatus which, during operation, is charged with a pressure above the normal pressure, for example a gas-conducting region of a breathing apparatus above a normal pressure, for example above 1.5 bar, in particular above 2 bar. In particular, said gas-conducting element may be a respiratory-gas-conducting region of a breathing regulator, wherein the breathing regulator may in principle be a single-stage or a multi-stage breathing regulator. Here, the gas-conducting element may for example be a part of a first stage and/or of a second stage and/or optionally of further stages of the breathing regulator, or else may be a complete breathing regulator. For example, the gas-conducting element may be a region between a hose connection and a valve of a breathing regulator, or the gas-conducting element may comprise such a region.

A connection between the pressure connector and the gas-conducting element may generally be understood to mean a fluidic connection, in particular a gas connection, such that the pressurized fluid from the pressurizing device can be transferred into the gas-conducting element, in particular into an interior space of the gas-conducting element, preferably without a fluid loss and/or a pressure loss occurring in said connection. Furthermore, the connection between the pressure connector and the gas-conducting element may optionally comprise at least one mechanical connection, in particular a positively locking and/or non-positively locking connection, such that the gas-conducting element can be fixedly connected to the pressure connector. For example, said connection may be a screw connection and/or a clamped connection and/or a braced connection, for which purpose the pressure connector and/or the gas-conducting element may each have at least one mechanical connecting element. In particular, said connection may be a plug-in connection in the form of a quick-action coupling and/or may be a thread, for example a coupling piece for a breathing connector of a breathing regulator. A quick-action coupling is to be understood generally here to mean a gas-tight and/or liquid-tight plug-in connection between two fluid-conducting components, which connection can be mechanically secured by means of an easily and quickly establishable and releasable mechanical fixing, in particular without the use of a screw fastener, for example by means of at least one hook clamp and/or one bayonet fastener and/or one screw fastener, for example one sleeve nut. In particular, the connection may be establishable without the use of a tool. In particular, the pressure connector may comprise multiple fixed or exchangeable adapters for connection to different types of gas-conducting elements. By means of said adapters, multiple different gas-conducting elements can be directly or indirectly connectable to the pressure connector, for example different varieties and/or different types of gas-conducting element, for example of different brands or from different manufacturers. For example, an adapter set with multiple different coupling pieces (for example coupling pieces of a quick-action coupling) and/or threads for the connection of different gas-conducting elements may be provided. For example, these may involve different quick-action coupling systems and/or standard threads. Alternatively or in addition, the at least one pressure connector may however also be designed as a fixed pressure connector for a particular type of connecting element or for a particular type of gas-conducting element. It is particularly advantageous if the pressure connector and/or the coupling system are configured such that firstly no gas can escape when no counterpart is connected, and such that it is also not possible in this case for any other medium such as cleaning fluid to enter the gas-conducting element.

As stated above, the pressurizing device may in particular be configured to charge the gas-conducting element with compressed gas. Here, a compressed gas may generally be understood to mean any gas at a pressure above the normal pressure, that is to say at a pressure above 1 bar. This may in particular be a pressure above 1.5 bar, in particular above 2 bar, and particularly preferably above 3 bar. In particular, the pressurizing device may be configured such that the pressurization with the compressed gas takes place such that all cleaning fluid is kept away from an interior space, which is charged with the compressed gas, of the gas-conducting element. The compressed gas may for example be compressed air or some other gaseous medium at a positive pressure, for example nitrogen, carbon dioxide or the like. In particular, an inert gas may be used as compressed gas. The cleaning device may in particular be designed such that the pressurization by means of the pressurizing device is performed during at least one cleaning operation, for example during at least one program step of a single-step or multi-step cleaning program. In particular, the pressurization with the compressed gas may be performed at the same time as the cleaning fluid is applied to the gas-conducting element. The pressure connector may accordingly be arranged in particular within the cleaning chamber, such that the pressurization with compressed gas and the application of cleaning fluid can be performed simultaneously.

The pressurizing device may in particular have at least one element selected from the group comprising:
at least one external pressure connector for connecting to an external compressed-gas source outside the cleaning device, in particular an on-site compressed-gas line and/or a compressed-gas bottle;
a compressed-gas source integrated into the cleaning device, in particular an integrated compressed-gas bottle and/or an integrated compressor.

As stated above, the compressed-air connector may in particular comprise at least one positively locking and/or non-positively locking connecting element. Said connecting element may be configured to establish not only the gas-tight connection but also a mechanical connection to the gas-conducting element. In particular, said at least one connecting element may have at least one quick-action coupling and/or at least one thread. In general, the pressure connector may in particular be integrated entirely or partially into the cleaning basket. In general, the cleaning basket may in particular have at least one releasable compressed-gas connection to the cleaning device. The pressurizing device may in particular have at least one valve, in particular at least one valve that is controllable by the controller of the cleaning device.

As stated above, the cleaning chamber is configured to receive at least one cleaning basket with the articles for cleaning received therein. The cleaning basket may be reversibly introducible into the cleaning chamber. The cleaning basket itself may be part of the cleaning device or may also be regarded as separate from the cleaning device. The cleaning device may for example be designed as a set together with one or more cleaning baskets. In particular, however, the at least one cleaning basket may be designed as part of the cleaning device, wherein, however, said at least one cleaning basket may for example be reversibly introducible, independently of the rest of the cleaning device, into the cleaning chamber.

The expression “cleaning basket” as used here, also referred to as “wash basket”, is a broad expression that should be attributed its normal and conventional meaning as it is understood by a person skilled in the art. The expression is not limited to a special or amended meaning. In particular, the expression may, without limitation, relate to a portable receiving device in which articles for cleaning can be received and which can be introduced into a cleaning device, for example a washer, and subsequently removed from the cleaning device again in a cleaned state. Alternatively, the cleaning basket may for example also be fixedly installed in a cleaning device. For example, the cleaning basket may be fastened in a rail system of the cleaning device and, using said rail system, pushed into a cleaning chamber of the cleaning device and pulled out of the cleaning chamber again after a cleaning operation. Cleaning baskets may furthermore also be used for temporarily storing articles for cleaning. In particular, the cleaning basket may have a multiplicity of openings such that liquid can drip off in a downward direction. For example, the cleaning basket may generally have at least one basket rack. The cleaning basket may in particular be of substantially cuboidal form, with a basket base which may for example have a square or generally rectangular outline and which has a bearing surface for the purposes of setting the cleaning basket down on a flat worktop. One or more basket walls, for example with an upright edge and furthermore optionally other elements such as handles, may optionally extend upward from the basket base.

In particular, the articles for cleaning, or at least one part of the articles for cleaning, may be fixed in the cleaning basket as the cleaning fluid is applied. Accordingly, the cleaning basket may in particular have at least one fixing element for fixing the articles for cleaning in the cleaning basket. Said at least one fixing element may for example comprise the at least one pressure connector as described above, by means of which, for example, at least one gas-connecting element of the articles for cleaning can be fixed to the cleaning basket. Other types of fixing elements are however also possible in principle. Accordingly, the at least one fixing element may for example comprise at least one element by means of which the articles for cleaning can be fixed in non-positively locking and/or positively locking fashion to the cleaning basket, for example at least one clamp, at least one thread, at least one fixing strap, at least one hook or other fixing elements. It is furthermore also possible for at least one self-contained small-parts basket, in which small parts can be collectively cleaned, to be provided on or in the cleaning basket, wherein one or more other parts of the articles for cleaning can be received, in particular fixed, in the cleaning basket outside the small-parts basket.

As described above, the cleaning basket may be part of the cleaning device or may also be regarded as separate, or may be part of a set or kit that comprises the cleaning device and at least one cleaning basket. As stated above, the at least one movable cleaning element may be fastened entirely or partially to the cleaning device, for example within a chamber of the cleaning device. However, the at least one movable cleaning element may alternatively or additionally also be fastened entirely or partially to the at least one cleaning basket.

Accordingly, in a further aspect, a cleaning basket for use in a cleaning device according to the invention, for example according to one or more of the refinements described above and/or according to one or more of the embodiments described in more detail further below, is proposed.

The cleaning basket has at least one basket rack for receiving the articles for cleaning. The expression “basket rack” as used here is a broad expression that should be attributed its normal and conventional meaning as it is understood by a person skilled in the art. The expression is not limited to a special or amended meaning. In particular, the expression may, without limitation, relate to a mechanical main structure of the cleaning basket, which may in particular have a basket base and additionally one or more basket walls, which may in particular extend proceeding from the basket base. The basket rack may in particular be produced entirely or partially from at least one material selected from the group comprising a synthetic material and metal. The basket rack may for example be formed entirely or partially as a wire rack, for example as a wire grille. Alternatively or in addition, the basket rack may also be formed entirely or partially as a synthetic material rack, for example as a synthetic material rack with multiple openings, for example as a synthetic material grille. Overall, the basket rack may for example have one or more openings in order that cleaning fluid can flow out of an interior of the basket rack. The basket rack may for example entirely or partially have a cuboidal main structure, for example with a rectangular bearing surface.

The proposed cleaning basket furthermore has multiple movable cleaning elements. The movable cleaning elements are arranged so as to be movable relative to the cleaning basket and are configured to be set in motion by the cleaning fluid, in particular a flow of the cleaning fluid, and to exert a mechanical cleaning action on the articles for cleaning as the at least one cleaning fluid is applied to the articles for cleaning.

The at least one cleaning basket may in particular be designed as an open cleaning basket, for example as an upwardly open cleaning basket. In this way, the articles for cleaning can for example be freely placed or laid into the cleaning basket from above, and for example fixed therein.

In particular, as stated above, the basket rack may have at least one basket base, in particular an open or closed basket base. Furthermore, the basket rack may have at least one cleaning element carrier arranged above the basket base, wherein the articles for cleaning can be received between the basket base and the cleaning element carrier. The movable cleaning elements may each be fastened by way of one end to the cleaning element carrier and may furthermore have at least one freely movable part, in particular one freely movable end, the freely movable part being capable, owing to the gravitational force acting thereon, of extending to the articles for cleaning when the cleaning basket has been introduced into the cleaning chamber. The expression “cleaning element carrier” as used here is a broad expression that should be attributed its normal and conventional meaning as it is understood by a person skilled in the art. The expression is not limited to a special or amended meaning. In particular, the expression may, without limitation, relate in principle to any sub-device of the basket rack that is configured to hold the movable cleaning elements. In particular, the cleaning element carrier may comprise at least one arm, which may for example be rigid or capable of being pivoted out, which extends at least partially above the basket base such that the articles for cleaning can be received between the arm and the basket base, from which the movable cleaning elements can extend in the direction of the articles for cleaning. For example, the movable cleaning elements may hang downward, in the form of ribbons or strands, from the arm to the articles for cleaning. There, said movable cleaning elements can be set in motion by the cleaning fluid. For example, the arm can be pivoted away for the purposes of loading and/or unloading the cleaning basket. In general, the cleaning element carrier may for example be a cleaning element carrier that can be pivoted out or pulled out or comprise at least one cleaning element carrier that can be pivoted out or pulled out.

As stated above, the cleaning device may in particular be configured such that at least one gas-conducting element of the articles for cleaning is pressurized as the cleaning fluid is applied to the articles for cleaning. Accordingly, the cleaning basket may be designed so as to have at least one pressure connector. The pressure connector may be connectable to at least one gas-conducting element of the articles for cleaning, in particular of the breathing apparatus. Via the pressure connector, the at least one gas-conducting element of the articles for cleaning can be charged with compressed gas as the at least one cleaning fluid is applied to the articles for cleaning. For further possible refinements, in particular with regard to the pressure connector and/or the compressed gas, reference may be made to the above description of the cleaning device.

In a further aspect, a method for cleaning articles for cleaning is proposed. The method comprises the steps listed below. The steps may be carried out in particular in the stated sequence. Furthermore, individual or several method steps may also be carried out at the same time, with a time overlap, or even repeatedly. The method may comprise further steps that are not mentioned.

The method comprises the following steps:
i. providing at least one cleaning device according to the invention, in particular according to one or more of the refinements described above and/or according to one or more of the embodiments described in more detail further below;
ii. placing the articles for cleaning in at least one cleaning basket;
iii. introducing the cleaning basket into the at least one cleaning chamber of the cleaning device; and
iv. applying the at least one cleaning fluid to the articles for cleaning in the cleaning chamber.

Here, the movable cleaning elements mechanically act on the articles for cleaning during the application in step iv. The movable cleaning elements are set in motion by the cleaning fluid. The movable cleaning elements remain in the cleaning chamber during the application.

For possible refinements of the method, and for definitions, reference may substantially be made to the above description of the cleaning device and of the cleaning basket.

The method may in particular be carried out such that the application in step iv. is performed by spraying, sprinkling, jetting or a combination of the abovementioned and/or other direct forms of application. This may be performed for example through corresponding design and/or actuation of the application device.

As stated above, step i. may in particular comprise fixing the articles for cleaning in the cleaning basket. For example, one or more fixing elements may be used for this purpose.

As also stated above, the method may be used in particular for cleaning personal protective equipment. Accordingly, the articles for cleaning may in particular comprise personal protective equipment, in particular breathing apparatus, for example including breathing protection masks and/or one or more gas-conducting elements such as compressed-air breathing apparatuses.

Accordingly, in a further aspect, the use of the cleaning device is proposed, for example cleaning device according to one or more of the refinements described above and/or according to one or more of the embodiments described in more detail further below. This proposed use of the cleaning apparatus relates to the use for cleaning personal protective equipment, in particular breathing apparatus.

The proposed cleaning device, the cleaning basket, the method and the use have numerous advantages over conventional devices and methods of similar type. In particular, the abovementioned disadvantages of conventional devices and methods can be substantially avoided. It is thus possible in particular to at least partially address the technical challenge whereby, in general, combustion residues can be removed only with difficulty using conventional cleaning fluids, for example water, washing pressure and corresponding chemical additives. In particular, the mechanical action also makes it possible to avoid an increase of the temperature, for example an increase of the temperature to over 45° C. The additional mechanical action also makes it possible for the electrostatic adhesion effects to be at least substantially reduced, by virtue of the movable cleaning elements being used to impart an additional mechanical rubbing action. A cleaning operation can generally be improved by a direct mechanical component of the cleaning action, whereby contaminants can be removed more effectively.

The cleaning device and the cleaning basket can be easily technically implemented. For example, in addition to a washing system as used previously, solid components in ball form, strand form or ribbon form can be introduced as movable cleaning elements into the cleaning chamber and/or into the cleaning basket for the purposes of mechanically processing the articles for cleaning, in particular for the purposes of mechanically rubbing away contaminants.

For example, movable cleaning elements in the form of balls may be used. Said balls may for example be introduced into the cleaning chamber. The balls may be of lightweight design, and may for example be of only such a size that they can remain situated above a lower nozzle system in the cleaning chamber and/or in the cleaning basket. For example, the balls may be moved, for example thrown around, in the cleaning chamber by the pressure and/or the spray jets of the cleaning device, wherein a mechanical action can be exerted on the articles for cleaning, and in particular, contaminants can be rubbed off the articles for cleaning. The balls may for example have a textile lining, for example a cotton lining. The textile lining may in particular be durable and exhibit no or only little wear. The textile lining can furthermore absorb contaminants. Instead of a textile lining, the balls may also be produced entirely from a textile material.

Alternatively or in addition to the use of balls, the movable cleaning elements may in particular have strands, as stated above. For example, movable cleaning elements, such as multiple individual flexible strands, may be attached in an upper region of the cleaning chamber, which movable cleaning elements hang downward. Said strands can lie on the articles for cleaning and/or hang next to the articles for cleaning. Owing to the impulse transfer from the cleaning fluid, for example owing to the washing pressure and/or the spray jets of the application device, the strands can rub against the surfaces of the articles for cleaning and remove contaminants, additionally to the fluidic cleaning action. As materials for the strands, use may for example be made of natural fibers and/or cotton and/or synthetic materials, for example polyester or polyamide, for example Nylon®, and/or ethylene propylene diene monomer. Other materials may however also be used in principle.

Further alternatively or in addition to the use of balls and/or strands, the movable cleaning elements may furthermore in particular comprise ribbons, as stated above. For example, movable cleaning elements, such as multiple individual ribbons, may be attached in an upper region of the cleaning chamber, which movable cleaning elements hang downward. Said ribbons can lie on the articles for cleaning and/or hang next to the articles for cleaning. Owing to the impulse transfer from the cleaning fluid, for example owing to the washing pressure and/or the spray jets of the application device, the ribbons can rub against the surfaces of the articles for cleaning and remove contaminants, additionally to the fluidic cleaning action. As materials for the ribbons, use may in principle be made of textile materials and/or synthetic materials. For example, ribbons composed of at least one flexible synthetic material may be used, whether in the form of textile materials and/or in the form of strips. In particular, the at least one synthetic material may be selected from the group comprising: polyester; polyamide, for example Nylon®; ethylene propylene diene monomer; polyurethane. Alternatively or in addition, use may also be made of grinding nonwovens, in particular without abrasive components.

As likewise stated above, the cleaning device may have at least one freeing device which can make loading and/or unloading of the cleaning chamber easier, and which can for example prevent the movable cleaning elements from posing an obstruction during said loading and/or unloading process. Alternatively or in addition, undesired effects caused by the movable cleaning elements during particular program steps, in particular the drying step, can be avoided. The at least one freeing device may in particular have at least one pusher, which may for example be arranged on a ceiling of the cleaning chamber. For example, said at least one pusher can, when correspondingly actuated, for example when the cleaning chamber is opened, push the movable cleaning elements outward against a side wall of the cleaning chamber, and thus for example make the cleaning chamber and/or the articles for cleaning more easily accessible for loading and/or unloading.

As stated above, the movable cleaning elements may be arranged entirely or partially in the cleaning chamber, and may for example also be fastened to the cleaning chamber. However, the movable cleaning elements may alternatively or additionally also be fastened entirely or partially to at least one cleaning basket. For example, said movable cleaning elements may for example also be arranged entirely or partially on a mask holder and/or receptacle for the personal protective equipment. Furthermore, as stated above, the at least one cleaning basket may also have at least one cleaning element carrier, which may for example be fixed or capable of being pivoted out. A pivotable fastening can improve accessibility to the cleaning basket, for example to a mask holder, and thus for example also mounting of the articles for cleaning in the cleaning basket, for example mounting of at least one breathing protection mask in a mask holder. The cleaning element carrier may be designed to be fastened separately in the cleaning chamber and/or to be removable from the cleaning chamber, in particular easily.

As stated above, the movable cleaning elements are set in motion by the cleaning fluid itself. However, at least one further mechanism by which the movable cleaning elements can be additionally set in motion is furthermore also conceivable. For example, at least one movable element, for example in the form of an additional drive, is conceivable, in particular at least one vibrating plate or at least one suspension means that can move in different directions, for example to the right or left and/or forward and back, within the cleaning chamber. The movable cleaning elements can be additionally set in motion in this way.

In summary, without limiting further possible refinements, the following embodiments are proposed:

Embodiment 1: A cleaning device for cleaning articles for cleaning, in particular personal protective equipment and in particular breathing apparatus, comprising at least one cleaning chamber for receiving at least one cleaning basket, with the articles for cleaning received therein, in a static manner, furthermore comprising at least one application device for applying at least one cleaning fluid to the articles for cleaning, furthermore comprising multiple movable cleaning elements, the movable cleaning elements being arranged so as to be movable relative to the cleaning basket, the movable cleaning elements being configured to remain in the cleaning chamber as the cleaning fluid is applied to the articles for cleaning, the movable cleaning elements being configured to be set in motion by the cleaning fluid, in particular a flow of the cleaning fluid, and the movable cleaning elements being configured to exert a mechanical cleaning action on the articles for cleaning as the cleaning fluid is applied to the articles for cleaning.

Embodiment 2: The cleaning device according to the preceding embodiment, the movable cleaning elements being produced at least partially from a flexible material.

Embodiment 3: The cleaning device according to either one of the preceding embodiments, the movable cleaning elements being produced at least partially from a textile material, in particular a textile material selected from the group comprising: a woven fabric, a warp-knitted fabric, a weft-knitted fabric, a braided fabric; a stitch-bonded fabric; a nonwoven fabric; a felt.

Embodiment 4: The cleaning device according to the preceding embodiment, the textile material having at least one material selected from the group comprising: a natural fiber; cotton; a textile synthetic material, in particular a textile synthetic material selected from the group comprising: polyester; polyamide.

Embodiment 5: The cleaning device according to any one of the preceding embodiments, the movable cleaning elements being produced at least partially from at least one synthetic material, in particular at least one elastomer material, in particular a synthetic material selected from the group comprising: ethylene propylene diene monomer; polyurethane.

Embodiment 6: The cleaning device according to any one of the preceding embodiments, the movable cleaning elements being at least partially of elongate flexible form, in particular in the form of ribbons and/or strands.

Embodiment 7: The cleaning device according to any one of the preceding embodiments, the movable cleaning elements having at least one shape selected from the group comprising:

a ball shape; a strand shape; a ribbon shape.

Embodiment 8: The cleaning device according to any one of the preceding embodiments, the movable elements being fastened at least partially in the cleaning chamber.

Embodiment 9: The cleaning device according to the preceding embodiment, the movable cleaning elements each having at least one freely movable part, in particular a free end, which is configured to mechanically act on the articles for cleaning.

Embodiment 10: The cleaning device according to the preceding embodiment, the freely movable part lying on the articles for cleaning owing to gravitational force.

Embodiment 11: The cleaning device according to any one of the three preceding embodiments, the cleaning device having at least one freeing device, the freeing device being configured to mechanically separate the freely movable parts of the movable cleaning elements from the articles for cleaning.

Embodiment 12: The cleaning device according to the preceding embodiment, the freeing device having at least one pusher, the pusher being configured to push the freely movable parts of the movable cleaning elements away from the articles for cleaning.

Embodiment 13: The cleaning device according to either one of the two preceding embodiments, the freeing device having at least two sub-devices, the sub-devices being configured to move the freely movable parts of the movable cleaning elements away from the articles for cleaning in at least two different directions.

Embodiment 14: The cleaning device according to any one of the three preceding embodiments, the freeing device being configured to automatically mechanically separate the freely movable parts of the movable cleaning elements from the articles for cleaning when the cleaning chamber is opened, and to allow contact between the freely movable parts of the movable cleaning elements and the articles for cleaning again when the cleaning chamber is closed.

Embodiment 15: The cleaning device according to any one of the preceding embodiments, the movable cleaning elements being fastened at least partially to at least one movable element of the cleaning device, the cleaning device being configured to set the movable cleaning elements in motion by means of the movable element in addition to the movement caused by the cleaning fluid.

Embodiment 16: The cleaning device according to any one of the preceding embodiments, the movable element having at least one oscillating plate on a ceiling of the cleaning chamber.

Embodiment 17: The cleaning device according to any one of the preceding embodiments, furthermore comprising at least one pressurizing device with at least one pressure connector, the pressure connector being connectable to at least one gas-conducting element of the articles for cleaning, in particular of the breathing apparatus, the pressurizing device being configured to charge the gas-conducting element with compressed gas as the at least one cleaning fluid is applied to the articles for cleaning.

Embodiment 18: The cleaning device according to any one of the preceding embodiments, furthermore comprising at least one cleaning basket.

Embodiment 19: The cleaning device according to the preceding embodiment, the cleaning basket having at least one fixing element for fixing the articles for cleaning in the cleaning basket.

Embodiment 20: A cleaning basket for use in a cleaning device according to any one of the preceding embodiments, the cleaning basket having at least one basket rack for receiving the articles for cleaning, the cleaning basket furthermore having multiple movable cleaning elements, the movable cleaning elements being arranged so as to be movable relative to the cleaning basket, and the movable cleaning elements being configured to be set in motion by the cleaning fluid, in particular a flow of the cleaning fluid, and the movable cleaning elements being configured to exert a mechanical cleaning action on the articles for cleaning as the cleaning fluid is applied to the articles for cleaning.

Embodiment 21: The cleaning basket according to the preceding embodiment, the basket rack having at least one basket base, in particular an open or closed basket base, the basket rack furthermore having at least one cleaning element carrier arranged above the basket base, the articles for cleaning being receivable between the basket base and the cleaning element carrier, the movable cleaning elements each being fastened by way of one end to the cleaning element carrier, and the movable cleaning elements furthermore having at least one freely movable part, in particular a free end, the freely movable part being capable, owing to the gravitational force acting thereon, of extending to the articles for cleaning when the cleaning basket has been introduced into the cleaning chamber.

Embodiment 22: The cleaning basket according to the preceding embodiment, the cleaning element carrier being a cleaning element carrier that can be pivoted out or pulled out.

Embodiment 23: The cleaning basket according to any one of the preceding embodiments relating to a cleaning basket, furthermore comprising at least one pressure connector, the pressure connector being connectable to at least one gas-conducting element of the articles for cleaning, in particular of the breathing apparatus, the gas-conducting element being chargeable with compressed gas via the pressure connector as the at least one cleaning fluid is applied to the articles for cleaning.

Embodiment 24: A method for cleaning articles for cleaning, comprising the following steps:
i. providing at least one cleaning device according to any one of the preceding embodiments relating to a cleaning device;
ii. placing the articles for cleaning in the at least one cleaning basket;
iii. introducing the cleaning basket into the at least one cleaning chamber of the cleaning device; and
iv. applying the at least one cleaning fluid to the articles for cleaning in the cleaning chamber,
   the movable cleaning elements exerting a mechanical action on the articles for cleaning during the application in step iv., the movable cleaning elements being set in motion by the cleaning fluid, and the movable cleaning elements remaining in the cleaning chamber during the application.

Embodiment 25: The method according to the preceding embodiment, the application in step iv. being performed by spraying, sprinkling, jetting or a combination of the abovementioned and/or other direct forms of application.

Embodiment 26: The method according to either one of the preceding embodiments relating to a method, step i. comprising fixing the articles for cleaning in the cleaning basket.

Embodiment 27: The method according to any one of the preceding embodiments relating to a method, the articles for cleaning comprising personal protective equipment, in particular breathing apparatus.

Embodiment 28: The use of a cleaning device according to any one of the preceding embodiments relating to a cleaning device to clean personal protective equipment, in particular breathing apparatus.

### BRIEF DESCRIPTION OF THE FIGURES

Further details and features will emerge from the following description of exemplary embodiments, in particular in conjunction with the subclaims. Here, the respective features may be realized individually or severally in combination with one another. The invention is not restricted to the exemplary embodiments. The exemplary embodiments are schematically illustrated in the figures. Here, the same reference designations are used in the individual figures to denote elements which are identical or functionally identical or which correspond to one another in terms of their function.

In the figures:

FIG. 1 shows an exemplary embodiment of a cleaning device for cleaning articles for cleaning with an exemplary embodiment of a cleaning basket in a side view;

FIG. 2 shows an exemplary embodiment of a cleaning basket for use in a cleaning device in a front view;

FIGS. 3 and 4 show different states of an exemplary embodiment of a cleaning device in a plan view;

FIG. 5 shows the state of an exemplary embodiment of a cleaning device as illustrated in FIG. 4, in a front view; and

FIG. 6 shows a flow diagram of a method for cleaning articles for cleaning.

### DESCRIPTION OF THE EXEMPLARY EMBODIMENTS

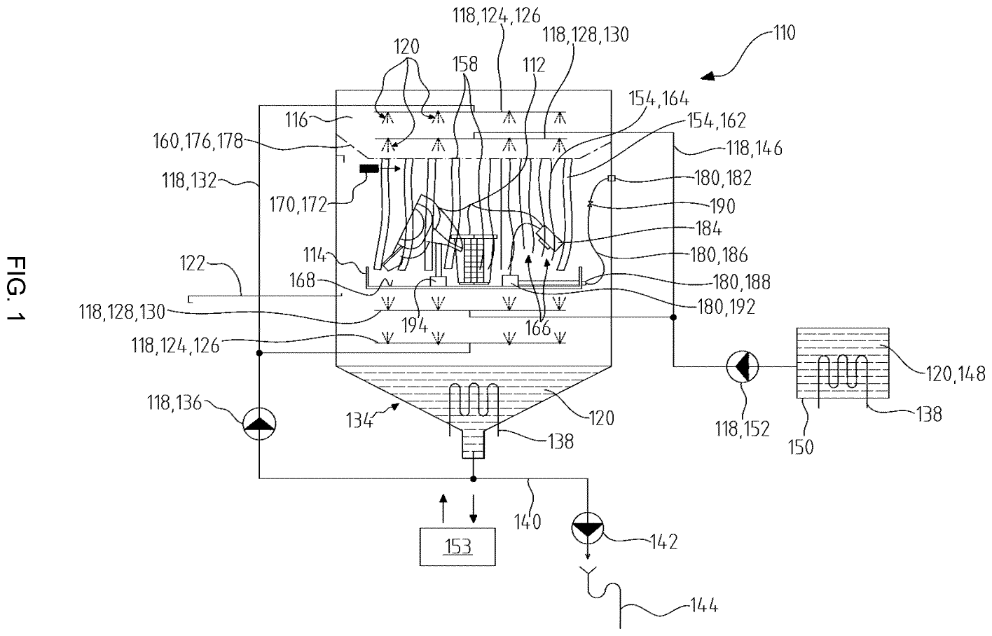

FIG. 1 shows exemplary embodiments of a cleaning device 110 for cleaning articles for cleaning 112, and of a cleaning basket 114, in a schematic sectional illustration from a side elevation. The cleaning device 110 for cleaning articles for cleaning 112, in particular for cleaning personal protective equipment and in particular breathing apparatus, comprises at least one cleaning chamber 116 for receiving the at least one cleaning basket 114, with articles for cleaning 112 received therein, in a static manner.

The cleaning device 110 furthermore comprises at least one application device 118 for applying at least one cleaning fluid 120 to the articles for cleaning. In particular, the application device 118 may for example in turn comprise one or more elements, for example one or more pipelines, one or more pumps and/or one or more tanks. For example, in the exemplary embodiment illustrated here, the cleaning device 110 is designed in particular as an industrial single-chamber washer, for example as a front-door washer with a door 122, with a multi-circuit wash system. The application device 118 may for example have a washing nozzle system 124, for example with one or more nozzle arms 126 with multiple nozzles, which nozzle arms are received above and/or below the breathing apparatuses 112 and are preferably mounted so as to be rotatable and/or swivelable. Alternatively or in addition, the application device 118 may also comprise a rinsing nozzle system 128, for example with one or more rinsing nozzle arms 130, which are preferably in turn mounted so as to be rotatable and/or swivelable and which may for example in turn be arranged above and/or below the breathing apparatuses 112. Other arrangements and/or refinements are however also possible in principle.

Furthermore, the application device 118 may for example have a washing line system 132 for charging the washing nozzle system 124 with cleaning fluid 120, for example from a washing tank 134. For example, the washing tank 134 may be provided in the base region of the cleaning chamber 116, and/or may in turn be connected in some other way to the cleaning chamber 116, such that, after being applied to the articles for cleaning 112, cleaning fluid 120 can flow and/or drip back into the washing tank 134 again. To charge the washing nozzle system 132 with the cleaning fluid 120 from the washing tank 134, the application device 118 may furthermore have one or more circulation pumps 136, in particular washing pumps. Furthermore, one or more heating elements 138 may be provided for purposes of heating the cleaning fluid 120 of the washing tank 134 and/or of other tanks. The washing tank 134 may in turn be capable of being emptied into a drain 144, for example via a discharge line 140 and optionally via a discharge pump 142.

The application device 118 may furthermore have a rinsing line system 146, via which, for example, the rinsing nozzle system 128 can be charged with a further cleaning fluid 120, for example with a rinsing liquid 148. In particular, the rinsing liquid 148 may for example be provided from a separate rinsing tank 150, and may preferably likewise be heatable by means of one or more heating elements 138. In order to charge the rinsing nozzle system 128, the application device 118 may for example have one or more rinsing pumps 152.

The cleaning device 110 may in particular comprise at least one controller 153. The controller 153 may for example be configured to control a cleaning operation, for example a cleaning program, in which the articles for cleaning 112, for example the at least one cleaning basket 114 with the articles for cleaning 112, are received in the cleaning chamber 116 in a static manner and have cleaning fluid 120 applied thereto successively in different ways in one or more cleaning steps of the cleaning program, for example firstly at least one washing fluid in at least one washing step and at least one rinsing liquid 148 in at least one rinsing step. Furthermore, at least one drying step may be provided, which may for example follow the application of the cleaning fluid 120 in the single cleaning chamber 116 while the articles for cleaning 112 are held in a static manner.

The cleaning device 110 furthermore comprises a multiplicity of movable cleaning elements 154, the movable cleaning elements 154 being arranged so as to be movable relative to the cleaning basket 114. In particular, the movable cleaning elements 154 are configured to remain in the cleaning chamber 116 as the cleaning fluid 120 is applied to the articles for cleaning 112. Furthermore, the movable cleaning elements 154 are configured to be set in motion by the cleaning fluid 120, in particular a flow of the cleaning fluid 120, the movable cleaning elements 154 being configured to exert a mechanical cleaning action on the articles for cleaning 112 as the cleaning fluid 120 is applied to the articles for cleaning 112.

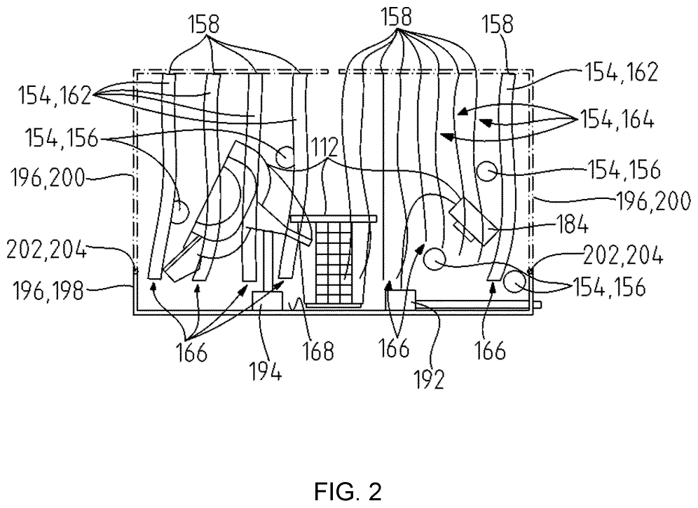

For example, the mobility of the movable cleaning elements 154 may be such that the cleaning elements 154 can move freely in the cleaning chamber 116. This may be the case for example if the movable cleaning elements 154 or at least a part of the movable cleaning elements 154 comprise multiple solid bodies, for example balls 156 illustrated by way of example in FIG. 2, which are freely movable in the cleaning chamber 116 but which cannot leave the cleaning chamber 116. The movable cleaning elements 154 may however alternatively or additionally also, at least in part, be designed to be only partially movable. This partial mobility is illustrated by way of example in the exemplary embodiment shown in FIG. 1, and may be realized for example by virtue of the movable cleaning elements 154 being fastened by way of at least one part, for example by way of a first end 158. For example, the cleaning elements 154 may be fastened, in particular by way of the first end 158, to at least one wall of the cleaning chamber 116 and/or to the cleaning basket 114. Alternatively or in addition, the cleaning elements 154 may be fastened by way of the first end 158 to a suspension means 160 that is attached in the cleaning chamber 116, for example to a grille. As illustrated in the exemplary embodiment shown in FIG. 1, the suspension means 160 may be used in particular if rotatably and/or swivelably mounted elements are arranged within the cleaning chamber 116 above the cleaning basket 114, for example the nozzle arm 126 and the rinsing nozzle arm 130 of the application device 118 in the exemplary embodiment shown here.

The movable cleaning elements 154 may, in particular irrespective of whether they are fastened by way of the first end 158 to a wall of the cleaning chamber 116, to the suspension means and/or to the cleaning basket, preferably designed to be movable by way of at least one other part, such that at least the movable part can mechanically act on the articles for cleaning 112 in the cleaning basket 114. This may be realized for example by virtue of the cleaning elements 154 being designed as ribbons 162, strips or strands 164, which have at least one freely movable part or one freely movable portion, for example one freely movable end 166, which can mechanically act on the articles for cleaning 112. For example, the movable cleaning elements 154, in particular the ribbons 162 and/or strands 164, may be dimensioned in terms of their length so as to extend from the fastened part, in particular from the first end 158, at least to the cleaning basket 114, in particular to a base 168 of the cleaning basket 114 or to just above same, such that said movable cleaning elements 154 can mechanically act by way of the freely movable part, for example by way of the freely movable end 166, on the articles for cleaning 112. For example, the freely movable part, in particular the freely movable end 166, may lie on the articles for cleaning owing to gravitational force. In particular, the movable cleaning elements 154 may be produced at least partially from a flexible material, for example from a textile material, such that the mechanical cleaning action includes, for example, rubbing with textile materials.

The cleaning device 110 may furthermore have, for example, a freeing device 170. Said freeing device 170 may for example may be configured to mechanically separate the freely movable parts of the movable cleaning elements 154 from the articles for cleaning 112. In particular, the freeing device 170 may have at least one pusher 172, which is for example configured to push the freely movable parts of the movable cleaning elements 154 away from the articles for cleaning 112. In the exemplary embodiment shown in FIG. 1, a possible movement direction of the pusher 172 is illustrated by way of example using an arrow. For example, the pusher 172 may push the movable cleaning elements 154 at least partially away such that it is made easier for the cleaning device 110 to be loaded and unloaded, in particular for the cleaning basket 114 to be introduced into and/or removed from the cleaning device 110.

In particular, the freely movable parts of the movable cleaning elements 154 may be pushed away automatically by the freeing device 170, for example in a manner controlled by the controller 153. In particular, the freeing device 170 may for example be configured to automatically mechanically separate the freely movable parts of the movable cleaning elements 154 from the articles for cleaning 112 when the cleaning chamber 116 is opened, and to allow contact between the freely movable parts of the movable cleaning elements 154 and the articles for cleaning 112 again when the cleaning chamber 116 is closed.

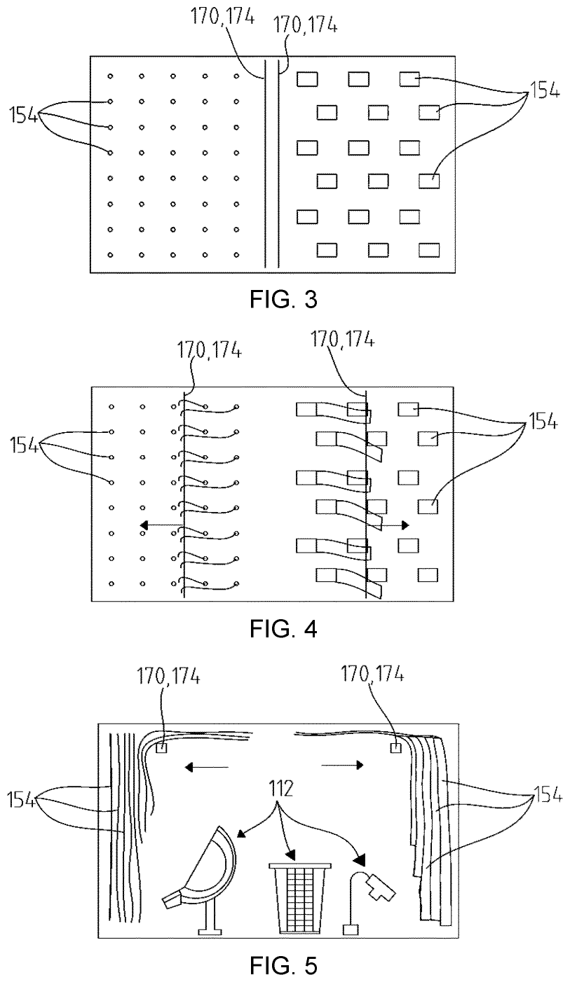

One possible refinement of the freeing device is illustrated by way of example in the exemplary embodiment of a cleaning device 110 shown in FIGS. 3 to 5. In particular, the freeing device 170 of the cleaning device 110 may for example have at least two sub-devices 174, the sub-devices 174 preferably being configured to move the freely movable parts of the movable cleaning elements 154 away from the articles for cleaning 112 in at least two different directions. The freeing device 170 may in particular be configured to automatically mechanically separate the freely movable parts of the movable cleaning elements 154 from the articles for cleaning 112 when the cleaning chamber 116 is opened. The freeing device 170 may furthermore be configured to automatically allow contact between the freely movable parts of the movable cleaning elements 154 and the articles for cleaning 112 again when the cleaning chamber 116 is closed.

FIG. 3 shows, by way of example, a plan view of a cleaning device 110 that is in a closed state. Here, in particular, the freeing device 170, for example with the at least two sub-devices 174, may be situated in a first position, in which contact is allowed between the articles for cleaning 112 (not illustrated in this figure) and the freely movable parts of the movable cleaning elements 154. FIG. 4 shows, by way of example, a plan view of a cleaning device 110 in an open or opened state, and FIG. 5 illustrates the open state of a cleaning device 110 as illustrated in FIG. 4, in a front view. Here, in particular, the freeing device 170, for example with the at least two sub-devices 174, may be situated in a second position, in which the freely movable parts of the movable cleaning elements 154 are mechanically separated from the articles for cleaning 112. FIGS. 3 to 5 each illustrate exemplary embodiments and arrangements of movable cleaning elements 154. Here, a multiplicity of cleaning elements 154 designed as strands 164 is shown on the left-hand side, whereas a multiplicity of cleaning elements 154 designed as ribbons 162 is illustrated on the right-hand side. A different design and arrangement are possible. In particular, it may for example be the case that only one embodiment of the cleaning elements 154 is present in a cleaning device 110, in particular only balls 156, only ribbons 162 or only strands 164. Alternatively, the embodiments of the cleaning elements 154 may also be mixed as desired. For example, cleaning elements 154 designed as balls 156 may be provided together with cleaning elements 154 designed as ribbons 162 and/or strands in a cleaning device 110. Furthermore, any desired arrangement of the cleaning elements 154 designed as strands 164 and/or ribbons 162 is possible. In particular, the cleaning elements 154, in particular the strands 164 and/or ribbons 162, may be arranged at regular intervals, for example in a regular pattern, in the cleaning device 110. Alternatively or in addition, an arrangement of the cleaning elements 154, in particular the strands 164 and/or ribbons 162, may for example be adapted to an arrangement of the articles for cleaning 112.

Furthermore, the movable cleaning elements 154 may be fastened at least partially to at least one movable element 176 of the cleaning device 116. Here, the cleaning device 110 may in particular be configured to set the movable cleaning elements 154 in motion by means of the movable element 176 in addition to the movement caused by the cleaning fluid 120. For example, the movable element 176 may have at least one oscillating plate 178 on a ceiling of the cleaning chamber 116. Accordingly, the suspension means 160 that is shown by way of example in FIG. 1 may preferably have at least one movable element 176. In particular, the suspension means may for example be designed as an oscillating plate 178.

As shown by way of example in FIG. 1, the cleaning device 110 may in particular furthermore have at least one pressurizing device 180 with at least one pressure connector, for example an external pressure connector 182. For example, the pressure connector 182 may be connectable to at least one gas-conducting element 184 of the articles for cleaning 112. Here, the pressurizing device 180 may in particular be configured to charge the gas-conducting element 184 with compressed gas, for example via a compressed-gas line 186 and a coupling 188, as the at least one cleaning fluid 120 is applied to the articles for cleaning 112. Here, the compressed-gas line 186 may for example have at least one valve 190. The coupling 188 may in particular be configured to connect the pressurizing device 180 of the cleaning device 110 to a further pressure connector 192. In particular, the pressure connector 192 may be arranged in the cleaning basket 114. The pressure connector 192 may for example be part of the cleaning basket 114. The cleaning device 110 may for example comprise the cleaning basket 114, such that the pressure connector 192 may preferably likewise be part of the cleaning device 110. Furthermore, the cleaning basket 114 may preferably have at least one fixing element 194 for fixing the articles for cleaning 112 in the cleaning basket 114.

An exemplary embodiment of the cleaning basket 114 for use in a cleaning device 110 is shown by way of example in FIG. 2 and comprises at least one basket rack 196 for receiving the articles for cleaning 112. The cleaning device 114 may furthermore comprise multiple movable cleaning elements 154, the movable cleaning elements 154 being arranged so as to be movable relative to the cleaning basket 114, and the movable cleaning elements 154 being configured to be set in motion by the cleaning fluid 120, in particular a flow of the cleaning fluid 120, and the movable cleaning elements 154 being configured to exert a mechanical cleaning action on the articles for cleaning 112 as the cleaning fluid 120 is applied to the articles for cleaning 112.

The basket rack 196 may in particular have at least one basket base 198, for example an open or closed basket base 198. Furthermore, the basket rack may have at least one cleaning element carrier 200 arranged above the basket base 198, wherein the articles for cleaning 112 may preferably be capable of being received between the basket base 198 and the cleaning element carrier 200. In particular, the movable cleaning elements 154 may each be fastened by way of one end, for example the first end 158, to the cleaning element carrier 200. Furthermore, the movable cleaning elements 154 may have at least one freely movable part, in particular comprising at least the freely movable end 166, the freely movable part being capable, owing to the gravitational force acting thereon, of extending to the articles for cleaning 112 when the cleaning basket 114 has been introduced into the cleaning chamber 116.

The cleaning element carrier 200 may for example be a cleaning element carrier 200 that can be pivoted out or pulled out. For example, the cleaning element carrier 200 may be capable of being pivoted out or pulled out in order to allow the articles for cleaning 112 to be loaded into and unloaded from the cleaning basket 114, for example in order to make it easier for the articles for cleaning 112 to be fixed to the fixing element 194. In particular, the cleaning element carrier 200 may for example be connected to the basket base 198 via at least one joint 202. Accordingly, the cleaning element carrier 200 may for example be of two-part form, as illustrated by way of example in the exemplary embodiment shown in FIG. 2, and may be connected to the basket base 198 via two hinges 204 and be capable of being pivoted out.

Furthermore, as stated above by way of example, the cleaning basket 114 may comprise the at least one pressure connector 192, wherein the pressure connector 192 may be connectable to the at least one gas-connecting element 184 of the articles for cleaning 112. In particular, via the pressure connector 192, the gas-conducting element 184 of the articles for cleaning 112 may be capable of being charged with compressed gas as the at least one cleaning fluid 120 is applied to the articles for cleaning 112.

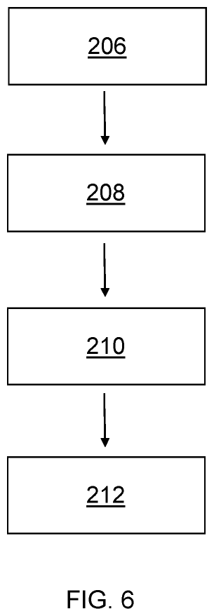

FIG. 6 shows a flow diagram of a method for cleaning articles for cleaning 112, the method comprising the following steps:
Step i. (denoted by reference designation 206) providing at least one cleaning device 110;
Step ii. (denoted by reference designation 208) placing the articles for cleaning 112 in the at least one cleaning basket 114;
Step iii. (denoted by reference designation 210) introducing the cleaning basket 114 into the at least one cleaning chamber 116 of the cleaning device 110; and
Step iv. (denoted by reference designation 212) applying the at least one cleaning fluid 120 to the articles for cleaning 112 in the cleaning chamber 116.

In particular, the movable cleaning elements 154 exert a mechanical action on the articles for cleaning 112 during the application in step iv., the movable cleaning elements 154 being set in motion by the cleaning fluid 120, and the movable cleaning elements 154 remaining in the cleaning chamber 116 during the application. The application in step iv. may be performed in particular by spraying, sprinkling, jetting or a combination of the abovementioned and/or other direct forms of application. Furthermore, step i. may for example comprise fixing the articles for cleaning 112 in the cleaning basket 114.

### LIST OF REFERENCE DESIGNATIONS

110 Cleaning device
112 Articles for cleaning
114 Cleaning basket
116 Cleaning chamber
118 Application device
120 Cleaning fluid
122 Door
124 Washing nozzle system
126 Nozzle arm
128 Rinsing nozzle system
130 Rinsing nozzle arm
132 Washing line system
134 Washing tank
136 Circulation pump
138 Heating element
140 Discharge line
142 Discharge pump
144 Drain
146 Rinsing line system
148 Rinsing liquid
150 Rinsing tank
152 Rinsing pump
153 Controller
154 Cleaning element
156 Ball
158 First end
160 Suspension means
162 Ribbon
164 Strand
166 Freely movable end
168 Base
170 Freeing device
172 Pusher
174 Sub-device
176 Movable element
178 Oscillating plate
180 Pressure application device
182 Pressure connector
184 Gas-conducting element
186 Pressurized gas line
188 Coupling
190 Valve
192 Pressure connector
194 Fixing element
196 Basket rack
198 Basket base
200 Cleaning element carrier
202 Joint
204 Hinge
206 Step i.
208 Step ii.
210 Step iii.
212 Step iv.

1. A cleaning device for cleaning articles for cleaning, in particular personal protective equipment and in particular breathing apparatus, comprising at least one cleaning chamber for receiving at least one cleaning basket, with the articles for cleaning received therein, in a static manner, furthermore comprising at least one application device for applying at least one cleaning fluid to the articles for cleaning, furthermore comprising multiple movable cleaning elements, the movable cleaning elements being arranged so as to be movable relative to the cleaning basket, the movable cleaning elements being configured to remain in the cleaning chamber, as the cleaning fluid is applied to the articles for cleaning, the movable cleaning elements being configured to be set in motion by the cleaning fluid, and the movable cleaning elements being configured to exert a mechanical cleaning action on the articles for cleaning as the cleaning fluid is applied to the articles for cleaning, the movable cleaning elements being fastened at least partially in the cleaning chamber, the movable cleaning elements each having at least one freely movable part that is configured to mechanically act on the articles for cleaning, the cleaning device having at least one freeing device, the freeing device being configured to mechanically separate the freely movable parts of the movable cleaning elements from the articles for cleaning.

2. The cleaning device as claimed in claim 1, the movable cleaning elements being produced at least partially from a flexible material.

3. The cleaning device as claimed in claim 1, the movable cleaning elements being produced at least partially from a textile material, the textile material having at least one material selected from the group comprising: a natural fiber; cotton; a textile synthetic material.

4. The cleaning device as claimed in claim 1, the movable cleaning elements having at least one shape selected from the group comprising: a ball shape; a strand shape; a ribbon shape.

5-6. (canceled)

7. The cleaning device as claimed in claim 1, the freeing device having at least one pusher, the pusher being configured to push the freely movable parts of the movable cleaning elements away from the articles for cleaning.

8. The cleaning device as claimed in claim 1, the freeing device having at least two sub-devices, the sub-devices being configured to move the freely movable parts of the movable cleaning elements away from the articles for cleaning in at least two different directions.

9. The cleaning device as claimed in claim 1, the freeing device being configured to automatically mechanically separate the freely movable parts of the movable cleaning elements from the articles for cleaning when the cleaning chamber is opened, and to allow contact between the freely movable parts of the movable cleaning elements and the articles for cleaning again when the cleaning chamber is closed.

10. The cleaning device as claimed in claim 1, the movable cleaning elements being fastened at least partially to at least one movable element of the cleaning device, the cleaning device being configured to set the movable cleaning elements in motion by means of the movable element in addition to the movement caused by the cleaning fluid.

11. A cleaning basket for use in a cleaning device as claimed in claim 1, the cleaning basket having at least one basket rack for receiving the articles for cleaning, the cleaning basket furthermore having multiple movable cleaning elements, the movable cleaning elements being arranged so as to be movable relative to the cleaning basket, and the movable cleaning elements being configured to be set in motion by the cleaning fluid, and the movable cleaning elements being configured to exert a mechanical cleaning action on the articles for cleaning as the cleaning fluid is applied to the articles for cleaning.

12. The cleaning basket as claimed in claim 11, the basket rack having at least one basket base, the basket rack, furthermore having at least one cleaning element carrier arranged above the basket base, the articles for cleaning being receivable between the basket base and the cleaning element carrier, the movable cleaning elements each being fastened by way of one end to the cleaning element carrier, and the movable cleaning elements furthermore having at least one freely movable part, the freely movable part being capable, owing to the gravitational force acting thereon, of extending to the articles for cleaning when the cleaning basket has been introduced into the cleaning chamber.

13. The cleaning basket as claimed in claim 12, the cleaning element carrier being a cleaning element carrier that can be pivoted out or pulled out.

14. A method for cleaning articles for cleaning, in particular personal protective equipment and in particular breathing apparatus, comprising the following steps:
i. providing at least one cleaning device as claimed in claim 1;
ii. placing the articles for cleaning in the at least one cleaning basket;
iii. introducing the cleaning basket into the at least one cleaning chamber of the cleaning device; and
iv. applying the at least one cleaning fluid to the articles for cleaning in the cleaning chamber,
the movable cleaning elements exerting a mechanical action on the articles for cleaning during the application in step iv., the movable cleaning elements being set in motion by the cleaning fluid, and the movable cleaning elements remaining in the cleaning chamber during the application.

15. The use of a cleaning device as claimed in claim 1 to clean personal protective equipment.
